(19) United States
(12) Patent Application Publication
(10) Pub. No.: US 2007/0126334 A1
(43) Pub. Date: Jun. 7, 2007

(54) IMAGE DISPLAY UNIT, AND METHOD OF MANUFACTURING THE SAME

(76) Inventors: Akiyoshi Nakamura, Saitama-shi (JP); Tomoko Kozuka, Hiratsuka-shi (JP); Akira Mikami, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/671,285

(22) Filed: Feb. 5, 2007

Related U.S. Application Data
(63) Continuation of application No. PCT/JP05/15161, filed on Aug. 19, 2005.

(30) Foreign Application Priority Data
Aug. 25, 2004 (JP) 2004-245297

(51) Int. Cl. H01J 9/38; H01J 63/04

(52) U.S. Cl. 313/484; 445/73

(57) ABSTRACT

An image display unit having a back-side substrate on which a number of electron emission elements are arranged, and a front-side substrate which is opposed to a back-side substrate and has fluorescent patterns and light-shielding patterns arranged at positions corresponding to electron emission elements, wherein a marking area is provided at least two locations in an ineffective part of the inside of the front-side substrate, corresponding to alignment marks of a dry plate, and each marking area has three alignment marks. According to the present invention, it is unnecessary to change R, G, B masks whenever three color fluorescent patterns are exposed, and realignment between a mask and a substrate is unnecessary.

### CROSS-REFERENCE TO RELATED APPLICATIONS

This is a Continuation Application of PCT Application No. PCT/JP2005/015161, filed Aug. 19, 2005, which was published under PCT Article 21(2) in Japanese.

This application is based upon and claims the benefit of priority from prior Japanese Patent Application No. 2004-245297, filed Aug. 25, 2004, the entire contents of which are incorporated herein by reference.

### BACKGROUND OF THE INVENTION

1. Field of the Invention

The present invention relates to a flat image display unit using an electron emission element, and a method of manufacturing the unit.

2. Description of the Related Art

A flat image display unit has been developed as a next-generation image display unit in recent years. In the flat image display unit, a number of electron emission elements are arranged to be opposite to a fluorescent plane. An electron emission element is available in various types, and is basically a field emission type. A display unit using such an electron emission element is generally called a field emission display (called a FED hereinafter). As a type of FED, a display unit using a surface-conduction electron-emitter is also called a surface-conduction electron-emitter display (called a SED hereinafter). In this specification, the term FED is used as a generic name of FED including SED.

To obtain clear display characteristics of FED, it is necessary to form three RGB color patterns constituting a fluorescent plane and a light-shielding pattern called a black matrix by precise patterning. For this precise patterning, various methods such as photolithography and screen-printing are used. JP-A 10-326583(KOKAI) discloses a technique of manufacturing FED. JP-A 2002-351054(KOKAI) discloses a technique of aligning an exposure mask with a substrate to be processed.

However, in the prior art, it is necessary to prepare R, G, B masks for three color fluorescent substances, align an R mask to an object substrate and expose, change the R mask to a G mask, align the G mask to the object substrate and expose, and change the G mask to a B mask, and align the B mask to the object substrate and expose. This takes much time to change masks and align masks to a substrate, and throughput is low. Further, as R, G, B masks are changed to each of three color fluorescent substances; alignment must be repeated whenever a mask is changed. This decreases accuracy of alignment.

### BRIEF SUMMARY OF THE INVENTION

It is an object of the present invention to provide an image display unit with high productivity and quality at low cost, and a method of manufacturing the unit.

An image display unit comprising a back-side substrate on which a number of electron emission elements are arranged, and a front-side substrate which is opposed to a back-side substrate and has fluorescent patterns and light-shielding patterns arranged at positions corresponding to electron emission elements, wherein a marking area is provided at least two locations in an ineffective part of the inside of the front-side substrate, corresponding to alignment marks of a dry plate, and each marking area has three alignment marks.

The above alignment mark is preferably over 0.06 mm and below 2 mm in a two-dimensional plane size. The “two-dimensional plane size” is defined as a maximum diameter of an alignment mark on a main surface of a substrate. If a two-dimensional plane size is lower than 0.06 mm, a magnifying power of a camera needs to be increased. This increases the cost of an alignment apparatus, and decreases the mark identification easiness. Contrarily, if a two-dimensional plane size is higher than 2 mm, the size of mark becomes too large, and a balance to a pixel size becomes bad, lowering the accuracy of alignment.

A marking area (a drawing area) is preferably within a circular range with a diameter of 6 mm. If a marking area exceeds the 6 mm diameter, an alignment mark is likely come out of a visual field of a camera, and alignment takes much time. A shape of a marking area may be circular or square, and a visual field of a camera may also be circular or square. If a visual field of a camera is square, a visual field size L1×L2 can be set to 4 mm×4 mm, for example.

An alignment mark is preferably printed in each marking area provided at four corners of the inside of a front-side substrate. Alignment marks at four corners of a rectangular substrate facilitate alignment and increase the accuracy in alignment of a column pattern of same color and a row pattern of repetitively arranged three R/G/B colors.

An alignment mark can be formed by any one of photolithography and printing (including a seal transfer method). Alignment accuracy is higher in photolithography, and photolithography is preferable. If a printing method is used, screen-printing is most preferable. A process of forming an alignment mark can also be performed simultaneously with a process of forming a black matrix light-shielding layer for forming vertical and horizontal partition lines which divide a fluorescent layer like a matrix.

An alignment mark is preferably three circular marks arranged in series at predetermined intervals (refer to FIGS. 5A-5D). An alignment mark is preferably three circular marks arranged at the vertexes of a triangle having a predetermined side length (refer to FIGS. 6A-6D). An alignment mark may be any one of circle, square, rectangle, cross, T-shape, double circle and doughnut. A circular mark is most preferable from the viewpoint of easiness in patterning in photolithography and ease of printing.

A two-dimensional plane size of a marking area is preferably less than 10 times of a unit length of R/G/B pixel composed of three color fluorescent patterns. If an alignment mark size is lower than 1 time (equal size) of R/G/B pixel, a magnifying power of a camera needs to be increased, and the cost of an alignment apparatus is increased. Contrarily, if an alignment mark size is lower than 10 times of R/G/B pixel, a mark size becomes too large, a balance to a pixel size becomes bad, and the accuracy of alignment is decreased.

A method of manufacturing an image display unit by aligning a front-side substrate to a dry plate having a number of pattern holes, when forming a fluorescent plane on a front-side substrate opposed to a back-side substrate on which a number of electron emission elements are arranged, comprising:

(a) forming three translucent alignment marks in a marking area at least two locations of the dry plate;

(b) forming a light-shielding alignment mark as a part of a front-side substrate corresponding 1:1 to an alignment mark of the dry plate, in a marking area at least two locations of an ineffective part of the front-side substrate where a fluorescent pattern is not formed;

(c) observing a state of overlapping of alignment marks of the substrate and the dry plate from a front side of the dry plate for each marking area, in a state that the dry plate and a front-side substrate are arranged parallel, and the front-side substrate is lit from a backside; and

(d) aligning relatively the front-side substrate to the dry plate, so that a state of overlapping of alignment marks of the substrate and the dry plate within a visual field of a photographing means is balanced in at least two marking areas.

In the above method, the substrate alignment mark and dry plate alignment mark are circular marks, the diameter of the substrate alignment mark is smaller than the diameter of the dry plate alignment mark, and the front-side substrate and dry plate are relatively aligned in a step (d), so that the substrate alignment mark comes into the dry plate alignment mark in a visual field of a camera in all marking area. As the diameter d1 of the substrate alignment mark is smaller than the diameter d2 of the dry plate alignment mark, the substrate alignment mark can be easily identified, and the state of overlapping of alignment marks can be optimally balanced at least 2 locations, preferably 4 locations (refer to FIGS. 5A-5D and FIGS. 6A-6D).

The ratio of the diameters d1 and d2 of the substrate alignment mark and dry plate alignment mark is preferably within a range of 0.5-0.8. For example, the diameter d1 of the substrate alignment mark is 500±2 μm, and the diameter d2 of the dry plate alignment mark is 800±2 μm. If the ratio of the diameters d1 and d2 is lower than 0.5, an allowable displacement of the substrate alignment mark in the dry plate alignment mark becomes excessive, and the alignment accuracy is decreased. Contrarily, if the ratio of the diameters d1 and d2 is higher than 0.8, the substrate alignment mark becomes difficult to come into the dry plate alignment mark, and a part of the mark often comes outside. Thus, alignment becomes difficult to be balanced in at least 2 marking areas (preferably 4 locations), and the alignment accuracy is decreased.

### BRIEF DESCRIPTION OF THE SEVERAL VIEWS OF THE DRAWING

FIG. 1 is a block diagram of an apparatus used for manufacturing an image display unit of the present invention;

FIG. 2 is a perspective view of a dry plate and a front-side substrate at the time of alignment;

FIG. 3A is a plan view of a front-side substrate with alignment marks;

FIG. 3B is a plan view of a front-side substrate with another type of alignment marks;

FIG. 4A is a plan view of a dry plate with alignment marks;

FIG. 4B is a plan view of a dry plate with another type of alignment marks;

FIG. 5A is an enlarged plan view showing a state of overlapping of alignment marks of a substrate and a dry plate appeared in a visual field of a camera;

FIG. 5B is an enlarged plan view showing a state of overlapping of alignment marks of a substrate and a dry plate appeared in a visual field of a camera;

FIG. 5C is an enlarged plan view showing a state of overlapping of alignment marks of a substrate and a dry plate appeared in a visual field of a camera;

FIG. 5D is an enlarged plan view showing a state of overlapping of alignment marks of a substrate and a dry plate appeared in a visual field of a camera;

FIG. 6A is an enlarged plan view showing a state of overlapping of another types of alignment mark appeared in a visual field of a camera;

FIG. 6B is an enlarged plan view showing a state of overlapping of another types of alignment mark appeared in a visual field of a camera;

FIG. 6C is an enlarged plan view showing a state of overlapping of another types of alignment mark appeared in a visual field of a camera;

FIG. 6D is an enlarged plan view showing a state of overlapping of another types of alignment mark appeared in a visual field of a camera;

FIG. 7A is a perspective sectional view showing an example of a manufacturing process of an image display unit;

FIG. 7B is a perspective sectional view showing an example of a manufacturing process of an image display unit;

FIG. 7C is a perspective sectional view showing an example of a manufacturing process of an image display unit;

FIG. 8 is a plan view of an image display unit (FED) partially broken away, showing a fluorescent plane and a metal back layer of a front-side substrate;

FIG. 9 is an enlarged plan view of a part of a fluorescent plane of an image display unit;

FIG. 10 is a perspective view showing the outline of an image display unit (FED); and

FIG. 11 is a sectional view taken along lines A-A of FIG. 10.

### DETAILED DESCRIPTION OF THE INVENTION

Best mode of the invention will be explained hereinafter with reference to the accompanying drawings.

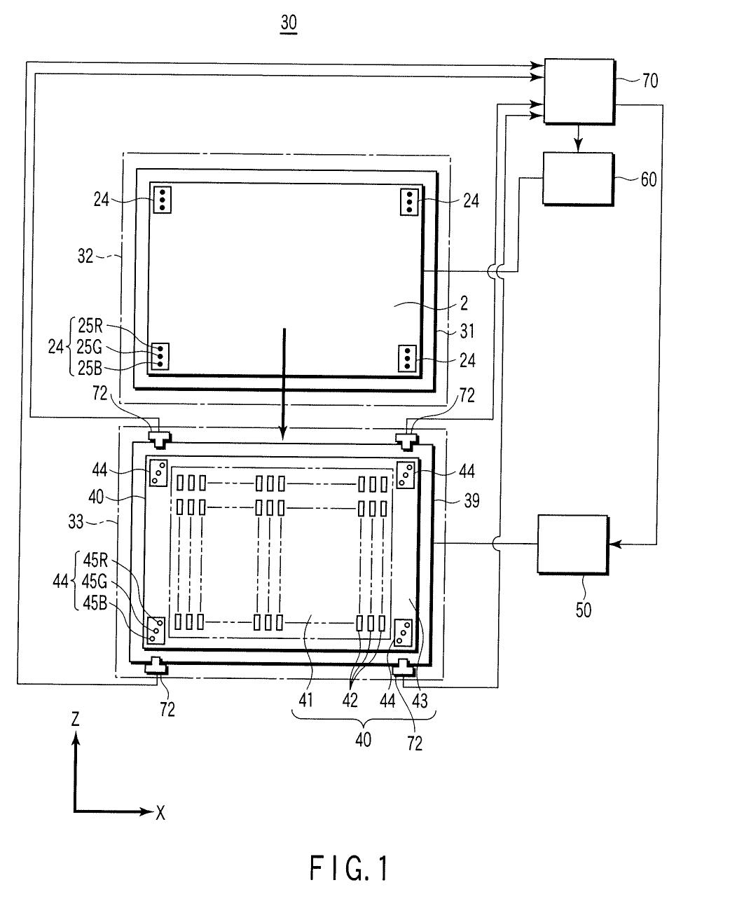

An alignment apparatus 30 used for manufacturing an image display unit of the invention has a substrate holder 31, a mask holder 39, a dry plate 40, a mask holder drive unit 50, a substrate holder drive unit 60, a controller 70, a CCD camera 72, and many other not-shown peripheral devices, as shown in FIG. 1. The alignment apparatus 30 is provided in an area from a standby unit 32 to an alignment unit 33, and a not-shown exposure unit is provided in this area or in proximity to this area.

The operations of the alignment apparatus 30 and exposure unit are subject to centralized control by a controller 70. The controller 70 controls the operations of the drive units 50 and 60 and exposure unit based on an image pickup signal sent from four CCD cameras 72, and aligns an object substrate 2 to the dry plate 40. Four cameras 72 are arranged corresponding to marking areas 44 provided at four corners of the dry plate 40.

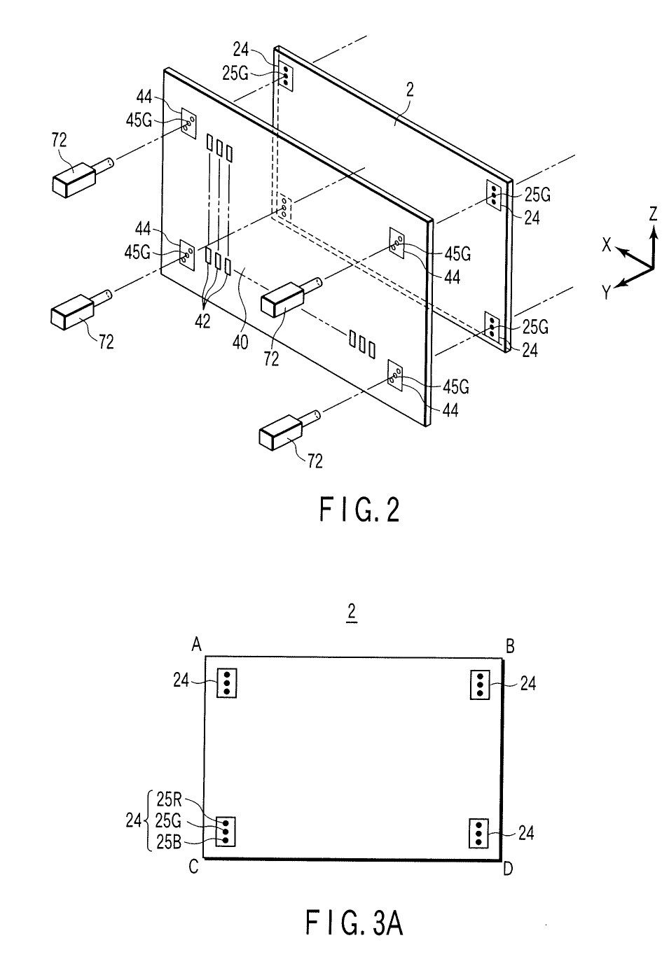

As shown in FIG. 2, the cameras 72 are arranged so that the optical axis of each camera extends along the Y-axis and passes through the marking areas 24 and 44 of the substrate and dry plate. A backlight (not shown) is provided in the rear of the object substrate 2, to light the substrate 2 from the rear side (the outside after FED is assembled). The cameras 72 are fixed at their positions not to be displaced from the substrate 2 driving system and dry plate 40 driving system. The dry plate 40 is fixed at its position with respect to the fixed cameras 72. The object substrate 2 is moved from the standby unit 32 to the alignment unit 33, and aligned to the dry plate 40 and camera 72.

The substrate holder 31 is provided movably from the standby unit 32 to the alignment unit 33, and has an alignment function to hold stationary and move the front-side substrate 2 as an object substrate. The substrate holder is rectangular and a little larger than the rectangular substrate 2, and has vacuum suction holes (not shown) at appropriate locations to absorb and hold the front-side substrate 2. The front-side substrate 2 is absorbed and held by the substrate holder 31, so that the longer side is faced to the X-axis direction and the short side is faced to the Y-axis direction, as shown in FIG. 2. The standby unit 32 serves as a home position for the object substrate 2, and lets the substrate stand by before alignment.

The substrate holder 31 is moved in X, Y and Z directions by three not-shown linear drive mechanisms, and rotated about the Y axis by a not-shown θ rotation drive mechanism. The operations of these drive mechanisms are controlled by the controller 70 by controlling the substrate drive unit 60 based on an alignment mark detection signal from the CCD camera 72.

The substrate holder drive unit 60 has not-shown two pairs of left and right linear guides and ball screws. The linear guides and ball screws extend in the Z-axis direction, and the ball screws engage with a nut (not shown). The nut is connected with one end of a holder for holding the object substrate 2 together with a frame (not shown). For corners of the holder are supported slidable by two pairs of left and right linear guides. The drive unit 60 is backup controlled by the controller 70, to control the timing to start and stop moving the substrate holder, and the moving amount. At the end of the linear guide, a stopper and a not-shown limit switch are provided to give a limit to a moving stroke of the substrate holder by the drive unit 60.

The mask holder 39 to absorb and hold the dry plate 40 is provided in the alignment unit. The mask holder 39 is movably supported by the drive unit 50, so as to be moved in the Y-axis direction while holding the dry plate 40. The dry plate 40 is one size larger than the object substrate 2, and the mask holder 39 is much larger than the substrate holder 31.

The dry plate holder drive unit 50 has not shown two pairs of left and right linear guides and ball screws. The linear guides and ball screws extend in the Z-axis direction, and the ball screws engage with a nut (not shown). The nut 54 is connected with one end of a mask holder 39 for holding the dry plate 40 together with a frame (not shown). For corners of the holder 39 are supported slidable by two pairs of left and right linear guides. The drive unit 50 is backup controlled by the controller 70, to control the timing to start and stop moving the mask holder 39, and the moving amount. At the end of the linear guide, a stopper and a not-shown limit switch are provided to give a limit to a moving stroke of the mask holder 39 by the drive unit 50.

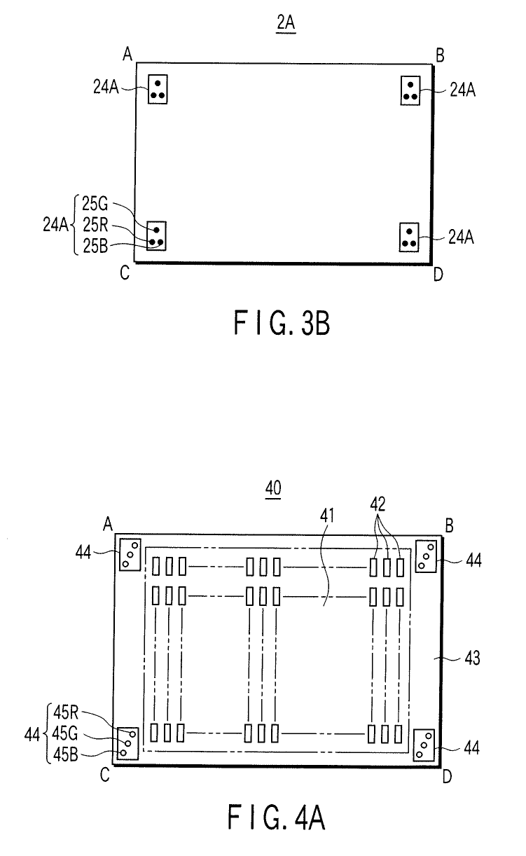

Next, explanation will be given on various substrates to be processed with reference to FIGS. 3A and 3B.

As shown in FIG. 3A, the object substrate 2 has a marking area 24 at four corners A, B, C and D (non-effective part 23). In each marking area 24, three light-shielding alignment marks 25R, 25G and 25B are arranged along a shorter side in series with an equal pitch. The alignment mark 25R is used for aligning a red pattern of three color fluorescent substances. The alignment mark 25G is used for aligning a green pattern of three color fluorescent substances. The alignment mark 25B is used for aligning a blue pattern of three color fluorescent substances. In the example shown in the drawing, the alignment marks 25R, 25G and 25B are sequentially arranged from the top to bottom. The order of arrangement is not limited to this in the present invention. The marks may be arranged in the order of 25G, 25B and 25R from the top to down, or in the order of 25G, 25R and 25B, or in the order of 25B, 25R and 25G, or in the order of 25B, 25G and 25R, or in the order of 25R, 25B and 25G.

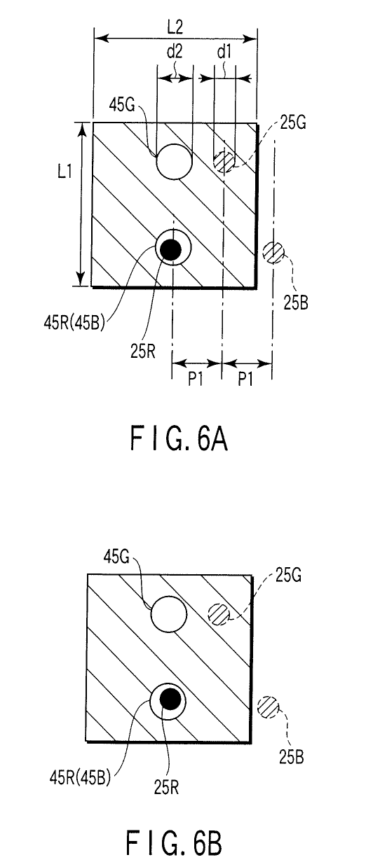

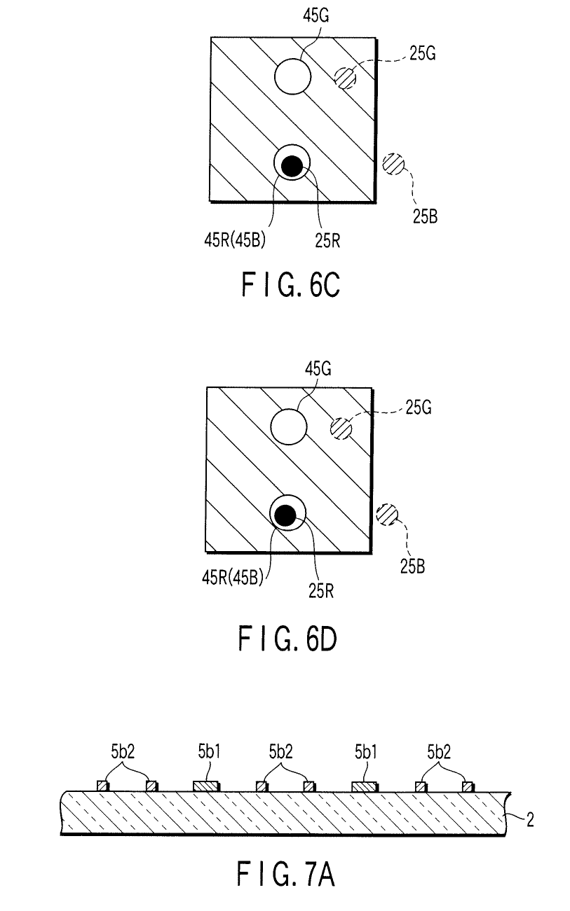

In another type object substrate 2A shown in FIG. 3B, each marking area 24A has three light-shielding alignment marks 25R, 25G and 25B arranged at the vertexes of an isosceles triangle or a regular triangle. Three marks 25R, 25G and 25B are arranged with an equal pitch P1, as shown in FIG. 6. In the example shown in the drawing, the alignment mark 25G is arranged at the vertex of a triangle. The arrangement is not limited to this in the invention. The alignment mark 25R or 25B may be arranged at the vertex of a triangle.

Photoresist is applied to the effective part 21 of the above object substrates 2 and 2A, the substrates are aligned to the dry plates 40 and 40A described later, and three color fluorescent patterns are sequentially exposed by the exposure unit.

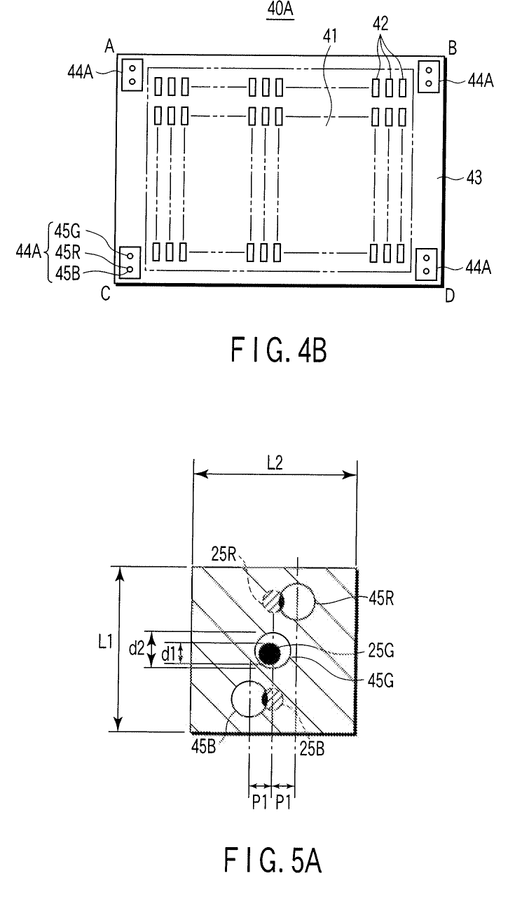

Next, various types of dry plate will be explained with reference to FIGS. 4A and 4B.

As shown in FIG. 4A, the dry plate 40 has a number of pattern holes 42 arranged regularly in a central pattern area (effective part) 41. These pattern holes 42 are used as openings to pass light to an object substrate at the time of exposure. The dry plate 40 has a marking area 44 at four corners A, B, C and D of a peripheral non-pattern area (ineffective part) 43. In each marking area 44, three translucent alignment marks 45R, 45G and 45B are diagonally arranged with an equal pitch (pitch P1). The alignment mark 45R is used for aligning a red pattern of three color fluorescent substances. The alignment mark 45G is used for aligning a green pattern of three color fluorescent substances. The alignment mark 45B is used for aligning a blue pattern of three color fluorescent substances. In the example shown in the drawing, the alignment marks 25R, 25G and 25B are sequentially arranged from the top to bottom. The order of arrangement is not limited to this in the present invention. The marks may be arranged in the order of 25G, 25B and 25R from the top to down, or in the order of 25G, 25R and 25B, or in the order of 25B, 25R and 25G, or in the order of 25B, 25G and 25R, or in the order of 25R, 25B and 25G.

In the other type of dry plate 40A shown in FIG. 4B, each marking area 44A has two translucent alignment marks 45G and 45R (compatible with 45B) arranged in series along the shorter side. The upper mark 45G is used for aligning a green pattern of three color fluorescent substances. The lower mark 45R (45B) is used for aligning red and blue patterns of three color fluorescent substances.

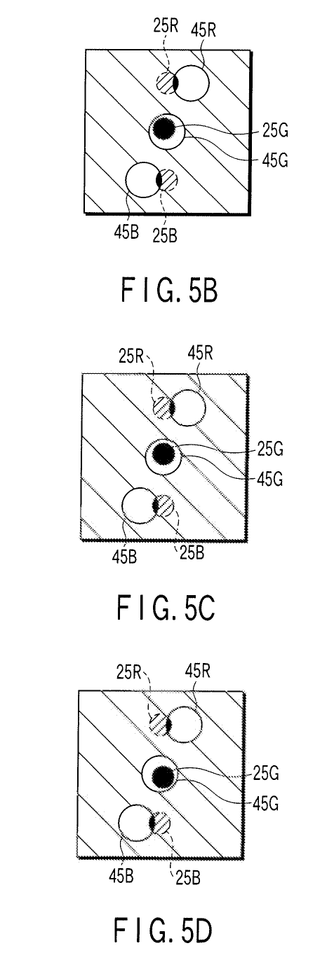

Next, alignment of the object substrate 2 to the dry plate 40 will be explained with reference to FIGS. 5A-5D.

FIGS. 5A, 5B, 5C and 5D show visual fields of cameras at four corners A, B, C and D at the time of aligning a green pattern. The marking area 44 of the dry plate 40 is covered with a light-shielding film like a black matrix, except the alignment marks 45R, 45G and 45B. In the visual field of a camera, only the substrate alignment mark 25G for a green pattern is seen, and the substrate alignment marks 25R and 25B for red and blue patterns are hidden by the light-shielding parts shown shaded in the drawings.

The substrate alignment mark 25G for a green pattern is within the translucent alignment mark 45G of the dry plate in the visual fields of the cameras at four corners A, B, C and D, and taken as an image by each camera 72. The taken four image signals are applied to the controller 70. Based on these input signals, the controller 70 moves the substrate holder drive unit 31 a little not to lose the balance of overlapping of the alignment marks 25G and 45G of the substrate and dry plate at four corners of A, B, C and D, fine-aligns the substrate 2 to the dry plate 40, and keeps the balance of overlapping of the alignment marks 25G and 45G at four corners of A, B, C and D.

In this embodiment, when the size of RGB pixel to be exposed as a pattern is 600 μm, the width of a rectangular fluorescent layer is 150 μm, and the space among the rectangular fluorescent layers is 50 μm, the size of a camera visual field L1×L2 is 4 mm×4 mm, the diameter d1 of the substrate alignment marks 25R, 25G and 25B is 500 μm, the diameter d2 of the dry plate alignment marks 25R, 25G and 25B is 800 μm, and the pitch P1 is 200 μm.

When the object substrate 2 is moved to the left side by the pitch P1 in the drawing, the whole alignment mark 25B for a blue pattern comes into the dry plate alignment mark 45B and aligned to a blue pattern, and the mark 25B can be taken as an image. When the object substrate 2 is moved to the right side by the pitch P1, the whole alignment mark 25R for a red pattern comes into the dry plate alignment mark 45R and aligned to a red pattern, and the mark 25R can be taken as an image.

Next, alignment of the object substrate 2A to the dry plate 40A will be explained with reference to FIGS. 6A-6D.

FIGS. 6A, 6B, 6C and 6D show visual fields of cameras at four corners A, B, C and D at the time of aligning a red pattern. The marking area 44A of the dry plate 40A is covered with a light-shielding film like a black matrix, except the alignment marks 45R, 45G and 45B. In the visual field of a camera, only the substrate alignment mark 25R for a red pattern is seen, and the substrate alignment mark 25G for a green pattern is hidden by the light-shielding part shown shaded in the drawings. The substrate alignment mark 25B for a blue pattern is out of the camera visual field.

The substrate alignment mark 25R for a green pattern is within the translucent alignment mark 45R of the dry plate in the visual fields of the cameras at four corners A, B, C and D, and taken as an image by each camera 72. The taken four image signals are applied to the controller 70. Based on these input signals, the controller 70 moves the substrate holder drive unit 31 a little not to lose the balance of overlap of the alignment marks 25R and 45R of the substrate and dry plate at four corners of A, B, C and D, fine-aligns the substrate 2A to the dry plate 40A, and keeps the balance of overlapping of the alignment marks 25R and 45R at four corners of A, B, C and D.

In this embodiment, when the size of RGB pixel size to be exposed as a pattern is 600 μm, the width of a rectangular fluorescent layer is 150 μm, and the space among the rectangular fluorescent layers is 50 μm, the size of a camera visual field L1×L2 is 4 mm×4 mm, the diameter d1 of the substrate alignment marks 25R, 25G and 25B is 100 μm, the diameter d2 of the dry plate alignment marks 25R, 25G and 25B is 400 μm, and the pitch P1 is 200 μm.

When the object substrate 2A is moved to the left side by the pitch P1 in the drawing, the whole alignment mark 25G for a green pattern comes into the dry plate alignment mark 45G and aligned to a green pattern, and the mark 25G can be taken as an image. When the object substrate 2A is moved to the right side by the pitch P1, the whole alignment mark 25B for a blue pattern comes into the dry plate alignment mark 45B (compatible with a red mark) in the lower side and aligned to a blue pattern, and the mark 25B can be taken as an image.

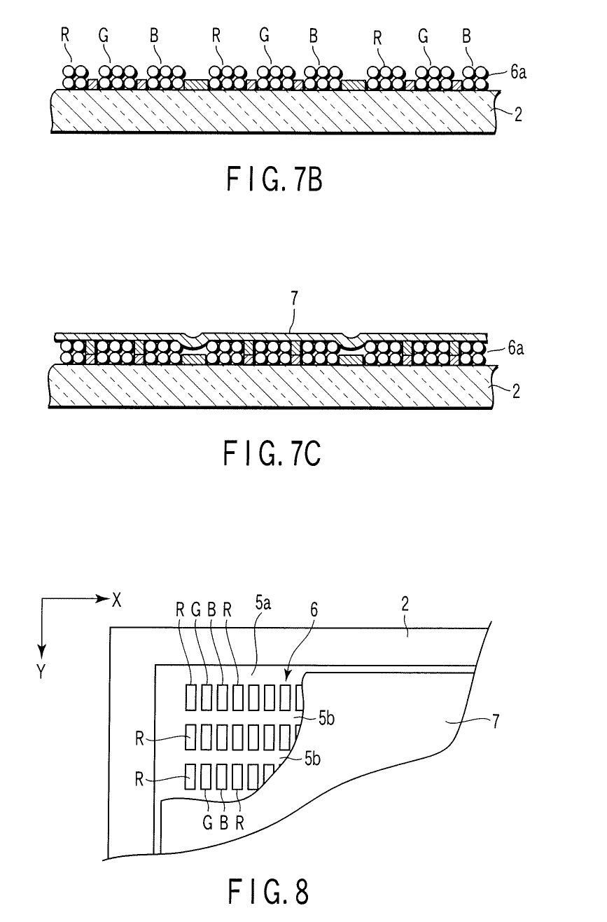

An explanation will be given on a method of manufacturing FED as an image display unit, particularly when manufacturing a front panel of an image display unit by using the above mentioned aligning apparatus, with reference to FIGS. 7A-7C.

Clean a glass substrate 2 as a front-side substrate of FED with a predetermined chemical solution, and obtain a desired clean surface. Coat the inside of the cleaned front-side substrate 2 with a light-shielding layer forming solution including a light-absorbing substance such as a black pigment. Heat and dry the coated film. Expose the film through a screen mask having apertures at positions corresponding to a matrix pattern. Develop the obtained latent image, and forms a matrix pattern of light-shielding layers 5b1 and 5b2 as shown in FIG. 7A.

Transfer the object substrate 2 to the substrate holder 31 by a not-shown carrier robot, and absorbs and holds the substrate. The receiving surface of the substrate holder 31 is made as a self-alignment structure, and the substrate 2 is automatically roughly aligned to the substrate 31. The object substrate 2 is a front-side substrate for FED, and coated with photoresist on the pattern-forming surface as described before. Absorb and hold the object substrate 2 with a vacuum chuck of the substrate holder 31, so that the resist-coated surface is set to the exposure unit side.

Then, move the substrate 2 from the standby unit 32 to the alignment unit 33, shoot the alignment marks with four cameras 72, and send the taken image signals to the controller 70. The controller 70 fine-aligns the substrate 2 to the dry plate 40 based on the image signals, whereby the substrate 2 is aligned to the dry plate 40.

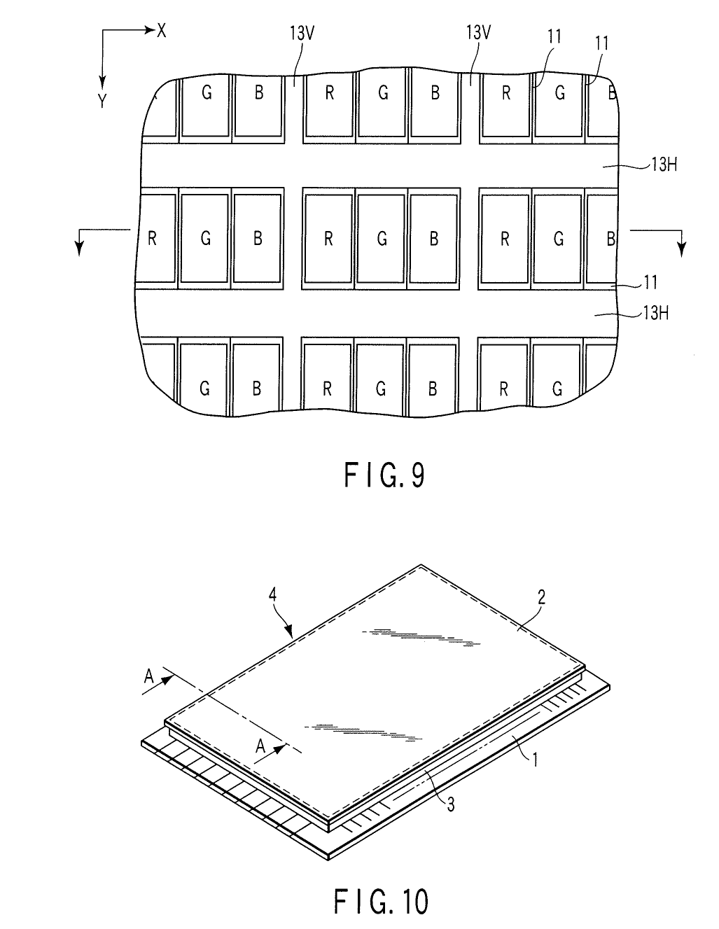

Coat the surface of the front-side substrate 2 to a predetermined thickness with a mixed solution prepared by mixing red (R) fluorescent particles in a photoresist solution (containing a solvent) at a predetermined ratio. Heat and dry the coated film. Expose, and develop the film through a screen mask having a aperture at a position corresponding to a red (R) pattern. As for green (G) and blue (B), form a predetermined pattern by the same photolithography. Finally, bake the substrate 2 to eliminate a photoresist, and obtain a fluorescent plane 6 having a RGB fluorescent layer 6a with three color rectangular or rectangular stripe shaped patterns arranged regularly in the vertical and horizontal directions as shown in FIG. 7B and FIG. 9. When a pixel is square with a pitch of 600 μm, for example, the width in the X direction of the vertical partition line 13V of the fluorescent layer 6a is 20-50 μm. The width of the vertical partition line 13V is defined by the intervals at the bottom of the adjacent fluorescent layers 6a regardless of a sectional form (rectangular, trapezoidal, inverse trapezoidal) of a fluorescent layer. The width in the Y direction of the horizontal partition line 13H (stripe) of the fluorescent layer 6a is 50-250 μm. A matrix of light-shielding layers 5b exists in these vertical and horizontal partition lines 13V and 13H, to prevent leakage of light to the front-side substrate 2.

Form a metal back layer 7 on the top face of the fluorescent layer 6a with the R/G/B segment patterns as shown in FIG. 7C. To form the metal back layer 7, form a thin film of organic resin such as nitrocellulose by a spin coating method, for example. Form an aluminum (Al) film on the formed organic resin thin film by vacuum evaporation. Finally, bake the formed film to eliminate organic substances.

Place the fluorescent plane 6 formed as above in a vacuum enclosure together with an electron emission element. Use a method of forming an evacuated envelope for this purpose, namely, vacuum sealing of the front-side substrate 2 having the fluorescent plane 6 and the back-side substrate 1 having a plurality of electron emission element 8 by a flint glass, for example. Further, evaporate a predetermined getter material on a pattern in the vacuum enclosure, and form an evaporated film in an area of the metal back layer 7.

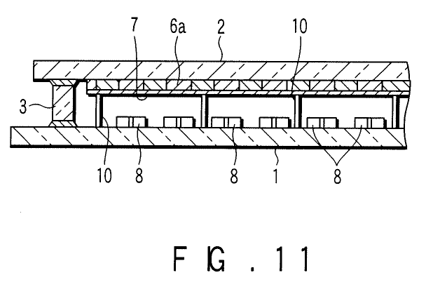

FIG. 10 and FIG. 11 show the structure of FED common to this embodiment. FED has a front-side substrate 2 and a back-side substrate 1, which are made of square glass and opposed at an interval of 1-2 mm. These front-side substrate 2 and back-side substrate 1 are joined in their peripheral edge portions through a rectangular frame-like sidewall, constituting a flat rectangular vacuum enclosure whose inside is kept in a high vacuum of approximately 10⁻⁴ Pa.

A fluorescent plane 6 is formed on the inside surface of the front-side substrate 2. The fluorescent plane 6 consists of a fluorescent layer 6a which emits three colors of red (R), green (G) and blue (B), and a matrix-like light-shielding layer 5b. A metal back layer 7, which functions as an anode and as a light reflection film to reflect the light from the fluorescent layer 6a, is formed on the fluorescent plane 6. Under the displaying operation, the metal back layer 7 is supplied with a predetermined anode voltage from a not-shown circuit.

A number of electron emission element 8, which emits an electron beam to excite the fluorescent layer 7, is provided on the inside surface of the back-side substrate 1. These electron emission elements 8 are arranged in several columns and rows corresponding to each pixel. The electron emission elements 8 are driven by a not-shown wiring arranged like a matrix. Between the back-side substrate 1 and front-side substrate 2, a number of plate-like or column-like spacers 10 are provided as reinforcements to withstand an atmospheric pressure acting on the substrates 1 and 2.

An anode voltage is applied to the fluorescent plane 6 through the metal back layer 7. An electron beam emitted from the electron emission element 8 is accelerated by the anode voltage, and collides against the fluorescent plane 6. The corresponding fluorescent layer 6a emits light, and an image is display.

FIG. 8 and FIG. 9 show the structure of the front-side substrate 2, particularly, the fluorescent plane 6 common to the embodiments of the invention. The fluorescent plane 6 has a number of rectangular fluorescent layers to emit red (R), green (G) and blue (B) light. Taking the longish side of the front-side substrate 2 as an X-axis and the width side orthogonal to the longish side as a Y-axis, the fluorescent layers R, G and B are repeatedly arranged with a predetermined gap in the X-axis direction, and the fluorescent layer of the same color is repeatedly arranged with a predetermined gap. A predetermined gap is allowed to fluctuate within an error range in manufacturing or within a tolerance range in designing, and a gap among the fluorescent layers 6a cannot be said a constant value in the XY plane, but it is considered almost a constant value for convenience of explanation.

The fluorescent plane 6 has light-shielding layers 5a and 5b. These light-shielding layers have a rectangular frame light-shielding layer 5a extending along the peripheral edge of the front-side substrate 2, and a matrix pattern of light shielding layers 5b extending like a matrix among the fluorescent layers R, G and B, inside the rectangular frame light-shielding layer 5a, as shown in FIG. 8.

According to the invention, after preparing a front-side substrate with alignment marks and a mask (dry plate) common to three color R/G/B fluorescent substances, and after once aligning the front-side substrate to the common mask, the three color R/G/B patterns can be sequentially exposed to the substrate without changing the mask, and throughput is largely increased.

Further, it is unnecessary to change the R, G, B masks whenever three color fluorescent patterns are exposed, and realignment of the mask to the substrate is unnecessary. Therefore, a displacement in three color fluorescent patterns can be decreased to 5 μm or less, and the alignment accuracy can be extremely increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image display unit comprising a back-side substrate on which a number of electron emission elements are arranged, and a front-side substrate which is opposed to a back-side substrate and has fluorescent patterns and light-shielding patterns arranged at positions corresponding to electron emission elements, wherein a marking area is provided at least two locations in an ineffective part of the inside of the front-side substrate, corresponding to alignment marks of a dry plate, and each marking area has three alignment marks.

2. The image display unit according to claim 1, wherein a two-dimensional plane size of the alignment mark is over 0.060 mm and below 2 mm.

3. The image display unit according to claim 1, wherein the marking area is within a circular range with a diameter of 6 mm.

4. The image display unit according to claim 1, wherein a two-dimensional plane size of the marking area is less than 10 times of a pixel composed of three color fluorescent patterns.

5. The image display unit according to claim 1, wherein the alignment marks are formed by patterning by photolithography in the marking areas provided at four corners of the inside of the front-side substrate.

6. The image display unit according to claim 1, wherein the alignment marks are three circular marks arranged in series at predetermined intervals, and smaller in size than alignment marks of the dry plate.

7. The image display unit according to claim 1, wherein the alignment marks are three circular marks arranged at vertexes of a triangle having a predetermined side length, and smaller in size than alignment marks of the dry plate.

8. A method of manufacturing an image display unit by aligning a front-side substrate to a dry plate having a number of pattern holes, when forming a fluorescent plane on a front-side substrate opposed to a back-side substrate on which a number of electron emission elements are arranged, comprising:
(a) forming three translucent alignment marks in a marking area at least two locations of the dry plate;
(b) forming a light-shielding alignment mark as a part of a front-side substrate corresponding 1:1 to an alignment mark of the dry plate, in a marking area at least two locations of an ineffective part of the front-side substrate where a fluorescent pattern is not formed;
(c) observing a state of overlapping of alignment marks of the substrate and the dry plate from the front side of the dry plate for each marking area, in a state that the dry plate and the front-side substrate are arranged parallel, and the front-side substrate is lit from a backside; and
(d) aligning relatively the front-side substrate to the dry plate, so that a state of overlapping of alignment marks of the substrate and the dry plate within a visual field of a photographing means is balanced in at least two marking areas.

9. The method according to claim 8, wherein alignment marks of the substrate and the dry plate are circular marks, a diameter of the alignment mark of the substrate is smaller than a diameter of the alignment mark of the dry plate, and the front-side substrate is relatively aligned to the dry plate in the step (d), so that the alignment mark of the substrate comes into the alignment mark of the dry plate within a visual field of a camera, in all marking areas.

10. The method according to claim 8, wherein alignment marks of the substrate and the dry plate are one of square, rectangular, cross, T-shape, double circle and doughnut, a diameter of the alignment mark of the substrate is smaller than a diameter of the alignment mark of the dry plate, and the front-side substrate is relatively aligned to the dry plate in the step (d), so that the alignment mark of the substrate comes into the alignment mark of the dry plate within the visual field of the camera, in all marking areas.
